(19) United States
(12) Patent Application Publication
(10) Pub. No.: US 2015/0090387 A1
(43) Pub. Date: Apr. 2, 2015

(54) Quick Assembly Bicycle Inner Tube

(71) Applicant: Shanghai TianMa Vancom Rubber Products Co., Ltd., Shanghai (CN)

(72) Inventor: Xue Yun Yang, Shanghai (CN)

(73) Assignee: Shanghai TianMa Vancom Rubber Products Co., Ltd., Shanghai (CN)

(21) Appl. No.: 14/285,589

(22) Filed: May 22, 2014

(30) Foreign Application Priority Data
Sep. 30, 2013 (CN) 201320609947.3

(51) Int. Cl. B60C 5/10; B23P 6/00

(52) U.S. Cl. CPC B60C 5/10; B23P 6/00
USPC 152/511; 29/402.09

(57) ABSTRACT

A quick assembly bicycle inner tube comprising a cylindrical hollow body strip with two distal ends, a valve, and end covers that are formed of round cup shaped bodies and end caps. The air valve is installed on the inner tube. The inner tube has two end covers (head covers), each of which is installed on a distal end of the tube. The end covers are made of the same material as the hollow body. Each end of the tube end covers has a closed end cap. The quick assembly bicycle inner tube and the method of installing the inner tube, eliminates the need for tools to disassemble the wheel set by allowing the user to manually remove and replace the inner tube without removing the wheel set from the bicycle. The inner tube is further easily folded into a flat shape to facilitate easy portability.

### CROSS-REFERENCE TO RELATED APPLICATION

This application claims priority to China application no. 201320609947.3 filed on Sep. 30, 2013, which is hereby incorporated by reference in its entirety.

### FIELD OF THE INVENTION

The present invention relates to bicycle inner tubes. More particularly, the invention relates to the quick assembly of pneumatic bicycle inner tubes.

### BACKGROUND OF THE INVENTION

In existing bicycle pneumatic inner tubes, the traditional bicycle pneumatic tire is composed of a pneumatic tire and a contiguously round inner tube. The typical inner tube is ring shaped to fit inside the pneumatic tire, and filled with compressed air. The wheel set is installed in the bicycle fork and the rear dropout frame, making it necessary to use tools or the help of professionals to disassemble the wheel set and also remove the tire and inner tube in order to fix air leaks in the inner tube. Due to the need for tools, if you are already out on a ride, even if you are carrying a spare inner tube, it is impracticable, time consuming and inconvenient to independently replace or fix the traditional round inner tube.

Accordingly, there is a need for manually fixing and changing an inner tube without disassembling the bicycle wheel set.

### SUMMARY OF THE INVENTION

The objective of the present invention is to provide a bicycle inner tube strip, with a simple manual repair or replacement process that does not require the use of tools or disassembly of the wheel sets. When inflated inside a pneumatic tire, the separately closed ends of the quick assembly bicycle inner tube according to the present invention will come very close to touching each other, and function similarly to a traditional round inner tube.

The present invention is achieved through the following technical solution, which is in accordance with claim 1.

According to an embodiment of the present invention, a quick assembly bicycle inner tube is provided, which comprises an elongated flexible inner tube having two distal ends and a valve installed on the inner tube. The body of the inner tube is hollow and comprises a long cylindrical tube strip with covered ends on both ends of the tube. The tube strip having distinct disconnected ends is thereby not formed as a contiguous ring. The main body is cylindrical, which comprises at each end of the body, the cylindrical (round cup-shaped) end coverings and an annular closed end cap. The outer and inner diameter of the cylindrical end covering is the same as the outer and inner diameter of the long strip hollow body. The outer diameter of the cylindrical end covering can be joined connection with the long strip hollow body. The annular closed end cap has a flat face which facilitates the ease in inflating the tube. When the tube is inserted into a tire and inflated the outer faces of the end caps will be opposite each other and in close enough contact to essentially form the shape of a traditional round inner tube.

Embodiments of the present invention have the following advantageous effects: there is no longer a need to use tools to remove the tire and inner tube. Instead, the inner tube of the present invention can be removed manually to save time and energy. When the quick assembly bicycle inner tube is deflated, it becomes flat, foldable, and easy to carry. According to an embodiment of the present invention, there is a method of installing a bicycle inner tube formed of a hollow strip body with two distal ends with end caps. The method comprises forming an opening between the bicycle tire and a wheel rim of the bicycle, while the wheel is engaged in a fork or a dropout frame of the bicycle; inserting one distal end of the inner tube in the opening and inserting the valve of the inner tube through a valve hole on the wheel rim, then guiding the inner tube through the opening while rotating; and inflating the inner tube until the distal ends come into close contact forming a ring.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a structural diagram of a side view of the quick assembly bicycle inner tube, according to an embodiment of the present invention.

FIG. 2 is a cross-sectional diagram of the covered head portion of the bicycle tube, according to an embodiment of the present invention.

FIG. 3 is a general diagram illustrating the assembly of the quick assembly bicycle inner tube onto a tire, according to an embodiment of the present invention.

FIG. 4 shows the assembly of the inner tube by first positioning the valve through the valve hole in the bicycle wheel, according to an embodiment of the present invention.

FIG. 5 shows a partial cross sectional view of the inner tube installed and inflated inside a bicycle tire, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

The quick assembly bicycle inner tube according to embodiments of the present invention will be further described in detail with reference to the accompanying drawings in the following description.

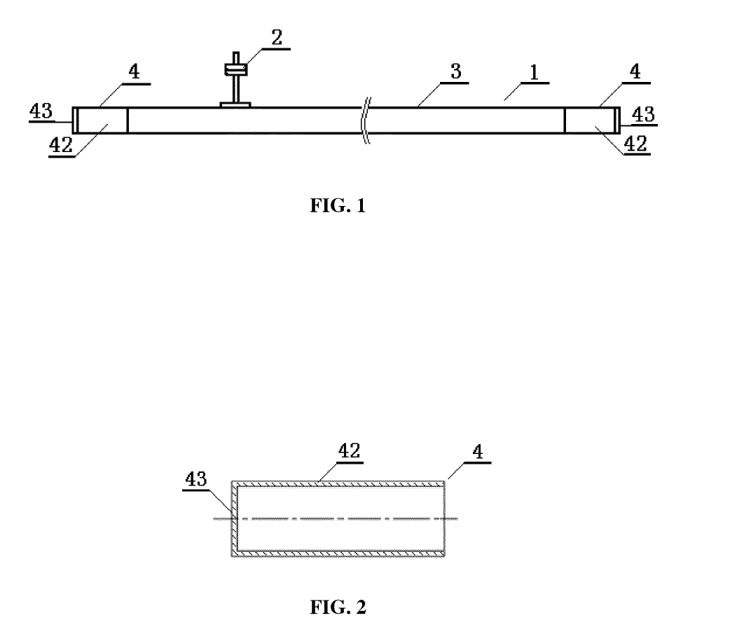

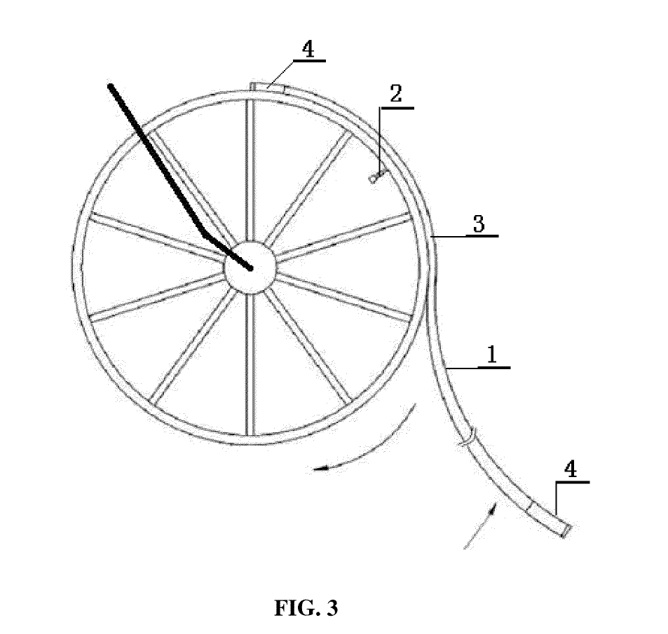

As shown in FIGS. 1 to 3, a quick assembly bicycle inner tube according to an embodiment of the present invention comprises a cylindrical rubber tube 1 having a hollow body 3, a valve 2, end coverings 4 with round cup body surfaces 42, and closed end caps 43. The quick assembly bicycle inner tube comprising cylindrical tube 1 includes the valve 2 which is installed on the inner tube. The inner tube has two end coverings 4, each of which is installed on both ends of the tube. The end coverings 4 are made of the same material as the hollow body 3. The main body is cylindrical and terminates at the two round cup bodies 42 on each end of the tube. Each end of the tube has a closed annular end cap 43 which has a flat face in the radial direction with respect to the length of the tube. The outer diameter and inner diameter of the round cup body 42 is the same as the outer and inner diameters of the hollow body 3.

The outer diameter of the round cup body 42 can be joined with the hollow body 3. According to an embodiment, as shown in FIG. 2, the round cup body 42 material is fused to the material of the hollow body 3. The closed annular end cap 43 can be flat. The face of the closed annular end cap 43 has an outer diameter which is joined to match the outer diameter of the distal end of the round cup body 42 at each end of the tube.

The inner tube of the present invention is replaced by removing the defective or flat inner tube by pushing the tire back from the rim of the wheel, for example by a tool to pry the tire away from the wheel rim, and pulling out one free end of the tube until the entire tube is pulled out. The defective tube can then be easily flattened, folded up and easily carried. If an existing conventional inner tube is in the tire, simply pull out some of the defective tube through the opening between the tire and wheel rim, cut the tube so that the defective tube can be slid out through the opening, without requiring any disassembly of the entire tire form the bicycle. The wheel set may stay intact and need not be disassembled in this process.

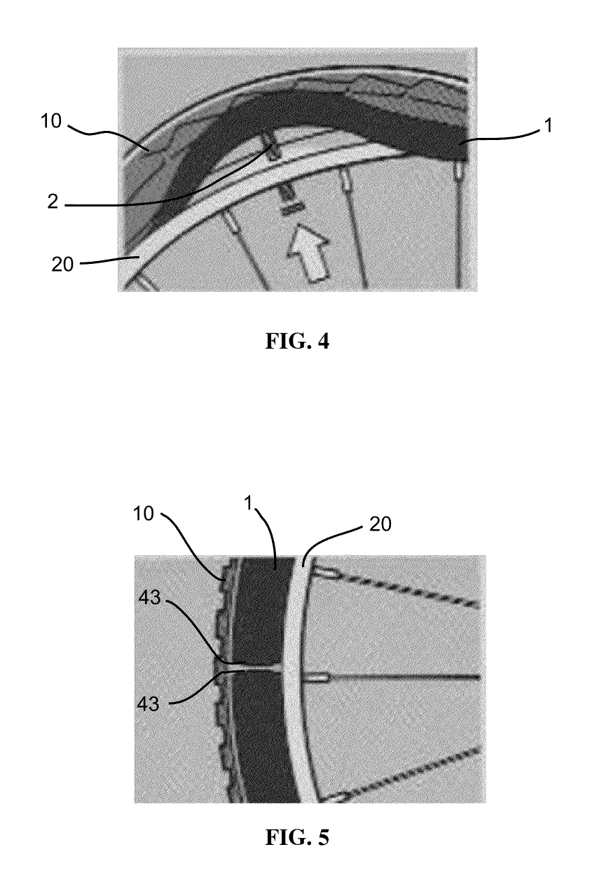

As shown in FIG. 4, to insert the new tube 1 into a tire 10, find the valve stem hole on the rim 20 of the wheel, pull back the tire 10 from the rim 20 and insert the free end of the tube where the valve stem 2 is closest to, and insert the valve stem 2 through the hole in the rim 20. The remainder of the inner tube strip is then guided into the tire 10 by pushing the tire 10 away from the rim 20 while rotating the tire 10 until all the inner tube 1 has been fully inserted and the distal ends 43 are in contact. The wheel is rotated while still on the fork or dropout frame, therefore requiring no disassembly. For ease in inserting the new tube, pump some air into the tube so that it has some body to it which will facilitate insertion into the tire.

As illustrated in FIG. 5, a partial cross section showing the tube 1 installed inside the tire 10 and resting against the wheel rim 20, as air is then pumped into the tube the closed distal ends 43 will press against each other closely to function as a traditional contiguously round inner tube. Accordingly, to change or fix an inner tube of the present invention requires no tools to disassemble or remove the wheel set from the bicycle. Such process saves time and energy.

According to an embodiment of the present invention, the inner tube 1 and all components, except for the valve 2, is manufactured of the same rubber material. The inner tubes are manufactured to match the size and design of a traditional inner tube specification such that it meets the specifications of tires. In the manufacturing method according to the present invention, the raw rubber material for the inner is cut to a specified length and size and made in the form of a hollow strip body. The end caps are connected to the hollow strip body and made of the same material as the hollow strip body.

According to an embodiment of the manufacturing method, as shown in FIG. 2, the round cup body 42 material is fused to the material of the hollow body 3. In particular, the outer diameter of each of the separately formed round cup bodies 42 is joined with the hollow body 3. The closed annular end cap 43 can be flat. The face of the closed annular end cap 43 has an outer diameter which is joined to match the outer diameter of the distal end of the round cup body 42 at each end of the tube. The raw material inner tube is put into a vulcanized can at 150 to 160 degrees C. for approximately 1 to 1.5 hours for strength and flexibility.

According to an embodiment of the present invention, there is a method of installing a bicycle inner tube formed of a hollow strip body with two distal ends with end caps. The method comprises prying a bicycle tire away from a wheel rim of the bicycle to form an opening, while the wheel is engaged in a fork or a dropout frame of the bicycle; inserting one distal end of the inner tube in the opening; inserting the valve through a valve hole on the wheel rim; guiding the inner tube through the opening while rotating the wheel; and inflating the inner tube until the distal ends come into close contact forming a ring. The installed inner tube therefore functions as a convention inner tube that is contiguously formed as ring since the distal ends press against each other to form the completed ring inside the tire.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

What is claimed is:

1. A quick assembly bicycle inner tube comprising:
a cylindrical hollow main body having disjoined distal ends;
a valve installed on the inner tube through the hollow main body;
a pair of cylindrical end covers, each cover installed on each distal end of the tube, wherein the pair of cylindrical end covers are formed of the same material as the hollow main body; and
a closed end cap on each end cover at each distal end.

2. The quick assembly bicycle inner tube of claim 1, wherein an outer diameter of each of the cylindrical end covers is joined to align longitudinally with an outer diameter of each distal end of the hollow main body.

3. The quick assembly bicycle inner tube of claim 1, wherein a face of each closed end cap is flat.

4. The quick assembly bicycle inner tube of claim 3, wherein a face of each closed end cap is flat in a radial direction, perpendicular to a longitudinal direction of the hollow main body.

5. The quick assembly bicycle inner tube of claim 1, wherein each closed end cap is joined to an outer diameter of each end cover.

6. The quick assembly bicycle inner tube of claim 1, wherein the inner tube has a length such that each closed end cap at each distal end touch each other to form a circle when the inner tube is inserted in a bicycle tire.

7. The quick assembly bicycle inner tube of claim 6, wherein a face of each of closed end cap is flat.

8. The quick assembly bicycle inner tube of claim 1, wherein the valve is located on the inner tube at a distance closer to one distal end than the other distal end.

9. A method of installing a bicycle inner tube for a bicycle, the inner tube comprising a cylindrical hollow main body having disjoined distal ends; a valve installed on the inner tube through the hollow main body; a pair of cylindrical end covers, each end cover installed on each distal end of the tube, wherein the end covers are formed of the same material as the hollow main body; and a closed end cap on each end cover at each distal end, the method comprising:
prying a bicycle tire away from a wheel rim of the bicycle to form an opening, while the wheel is engaged in a fork or a dropout frame of the bicycle;
inserting one distal end of the inner tube in the opening;
inserting the valve through a valve hole on the wheel rim;
guiding the inner tube through the opening while rotating the wheel; and
inflating the inner tube until the distal ends come into close contact forming a ring.
